(19) United States
(12) Patent Application Publication
(10) Pub. No.: US 2025/0026560 A1
(43) Pub. Date: Jan. 23, 2025

(54) BEVERAGE OR FOODSTUFF CONTAINER AND PREPARATION SYSTEM

(71) Applicant: SOCIETE DES PRODUITS NESTLE S.A., Vevey (CH)

(72) Inventors: GILLES GERBER, Penthaz (CH); AUDREY VIRGINIE MURPHY, Cossonay (CH); CHIARA PAVAN, Vullierens (CH); SANDOR KLAAS VEENJE, LM Workum (NL)

(21) Appl. No.: 18/714,866

(22) PCT Filed: Nov. 28, 2022
(86) PCT No.: PCT/EP2022/083410

§ 371 Date: May 30, 2024

(30) Foreign Application Priority Data
Dec. 1, 2021 (EP) 21211705.5

(51) Int. Cl. B65D 85/804; A47J 31/36; A47J 31/44

(52) U.S. Cl. CPC B65D 85/8046; A47J 31/3695; A47J 31/4492; B65D 85/8058; B65D 85/8064

(57) ABSTRACT

A container for use with a machine for preparing a beverage and/or foodstuff or a precursor thereof, the container including: a storage portion for containing a precursor material, a closing member to close the storage portion and an annular flange-like rim comprising an annular force ring made of a wood pulp-based material, wherein the annular force ring is of essentially S-shaped when seen in transversal cross-section. A set of different containers is also proposed as well as a container system and a system comprising a container and a beverage preparation machine.

### TECHNICAL FIELD

The present disclosure relates to a pre-portioned container containing a beverage or foodstuff precursor and to an electrically operated beverage or foodstuff preparation systems, with which a beverage or foodstuff is prepared from said pre-portioned container.

### BACKGROUND

Systems for the preparation of a beverage comprise a beverage preparation machine and a capsule. The capsule comprises a single-serving of a beverage forming precursor material, e.g. ground coffee or tea. The beverage preparation machine is arranged to execute a beverage preparation process on the capsule, typically by the exposure of pressurized, heated water to said precursor material. As part of this preparation process, the capsule is guided through the machine by a series of complex interactions to load, process and eject the capsule, by various mechanisms of the machine and principally a flange portion of the capsule. Processing of the capsule in this manner causes the at least partial extraction of the precursor material from the capsule as the beverage.

This configuration of beverage preparation machine has increased popularity due to enhanced user convenience compared to conventional beverage preparation machines (e.g. compared to a manually operated Moka pot/stove-top espresso maker).

Due to the complex movement of the capsule through the machine and the exposure to pressurized, heated water, to date only an aluminium based capsule has been implemented with a high degree of reliability. Indeed, other materials (like paper-based or pulp-based) material have been found to be prone to sticking in the machine or cause other material related errors. It results that aluminium capsule design (dimensions and geometrical design) cannot be directly applied on capsules made of different material than aluminium, for example on capsules made of cellulose-based material.

As an example, for technical reasons linked to the production process, certain designs available for aluminium capsules like the curl of the rim portion of certain capsules cannot be achieved for cellulose-based capsules.

It would then be desirable to develop capsule design working for capsules made for example of cellulose-based material and that may be produced according to the current available processes.

Therefore, in spite of the effort already invested in the development of capsule made of other material than aluminium or plastic, further improvements are desirable.

### SUMMARY

The present disclosure provides a container for use with a machine for preparing a beverage and/or foodstuff or a precursor thereof, the container including: a storage portion comprising a cavity with a base for containing a precursor material; a closing member to close the storage portion and a flange portion presenting the characteristics of claim 1.

In more details, the container is designed for insertion in and use with a preparation machine for preparing a beverage and/or foodstuff or a precursor thereof from a precursor material stored in the container by introducing liquid in the container and passing liquid through the precursor material. The container includes:
a container body at least partially made of cellulose pulp-based material comprising a bottom end and an open end, the container body forming a storage portion for containing the precursor material;
a closing member to close the storage portion at the open end of the container body; and
an annular flange-like rim at least partially made of cellulose pulp-based material, extending outwardly from the container body and connecting the storage portion and the closing member, the rim having at least a flat segment and comprising an annular force ring designed for being engaged by an enclosing member of the preparation machine.

According to the invention, the annular force ring is made of cellulose pulp-based material and is of essentially S-shaped when seen in transversal cross-section, comprising at least:
a first portion linked to the flat segment of the rim, and forming with said flat segment an angle comprised between 2° and 85°; and
a second portion extending from the first portion on the side opposite the flat segment of the rim, said second portion comprising at least a flat and/or curved extension.

The specific proposed design allows the production of cellulose-based container that may be used in existing beverage preparation machine in an accurate and secure way.

As for the dimensions of the flange-like rim, the flange-like rim which comprises the force ring, extends to a width comprised between 2 and 5 mm and has a thickness comprised between 150 and 600 microns.

The annular force ring additionally comprises a third portion extending between the flat segment of the flange-like rim and the first portion of the force ring. This third portion forming centering means for the container ensuring the container is correctly positioned in the preparation machine.

As disclosed, the first, second and third portions of the annular force ring are sections of the flange-like rim.

The container, including the flange-like rim with the annular force ring, is formed of cellulose pulp-based material that has a density of the material that is comprised between 200 and 500 gsm.

The container has an outer diameter (OD) comprised between 50 and 70 mm, preferably between 52 and 61 mm. The outer diameter has a fixed value to fit in a container holder of the extraction chamber of the beverage preparation machine.

In the proposed force ring design, the first and second portions of the force ring extend in a direction opposite the container body and beyond a plan (P) containing the flat segment of the flange-like rim, by an upward distance of extension (ha) from said plan (P). The upward distance of extension (ha) lies between 0.5 and 2 mm, preferably between 1 and 1.8 mm. The proposed design is advantageously conceived to be proposed in a cellulose-based material, for example in wood pulp-based material.

The third portion of the force ring extends in the direction of the container body below the plan (P) containing the flat segment of the flange-like rim, by a downward distance of extension (hb) from said plan (P). the downward distance of extension (hb) below the plan (P) is shorter than the up-ward distance of extension (ha) above the plan (P).

The third portion in its design is intended to interact with the beverage preparation machine, Advantageously, it forms centering means for the container when the capsule is positioned in the container holding portion of the preparation machine.

In a proposed embodiment, the flange-like rim comprises a code zone. The code zone may be located on the flat segment of the flange-like rim, optionally on the side facing the container body according to the beverage machine construction.

In addition to being directed towards a container, the invention also proposes a set of different containers for preparing in a preparation machine a beverage and/or foodstuff or a precursor thereof from a precursor material, comprising a container body having a total depth which differs for at least two containers of the set, preferably at least three containers of the set. This allows proposition beverages of different size in connection to consumer requirements or habits.

In the set of different containers, the containers further comprise an annular force ring having upward distance of extension from said plan (P), which differs for at least two containers of the set, preferably at least three containers of the set. Hence the valve means formed by the annular force ring interacting with the extraction chamber will differ for at least two containers of the set. This feature allows extracting the beverage with adequate crema quantity according to the defined recipe.

The invention also proposes a container system for preparing, in a preparation machine comprising an enclosing member, a beverage and/or foodstuff or a precursor in which the container is designed to form alone or in combination with the enclosing member of the preparation machine a restriction or restriction valve of the beverage and/or foodstuff and/or precursor exiting the container. Thanks to this it is possible to adjust the extraction parameter of the container and to modulate the quantity of crema produced during extraction.

The proposed invention further relates to a system comprising a container or one or more containers of a set of containers and a machine for preparing a beverage and/or foodstuff or a precursor thereof, the machine including a container holder for holding the capsule at least at the flange-like rim; a liquid injection means for feeding liquid in the container; a spring-biasing valve member for engaging the force ring of the container when the capsule is inserted in the machine; a processing unit for processing the precursor material of the container, the processing unit comprising the penetrator, and an electrical circuitry to control the processing unit.

The invention also relates to the use of a container or of one or more of the containers of the set of containers in a centrifugal beverage machine. In the proposed use, the container is centrifuged in the machine and the annular force ring is engaged by the enclosing member of the beverage machine; such force ring forming part of a valve means for selectively blocking and or restricting the flow of the centrifugal liquid coming out of the container.

The preceding summary is provided for purposes of summarizing some embodiments to provide a basic understanding of aspects of the subject matter described herein. Accordingly, the above-described features are merely examples and should not be construed to narrow the scope or spirit of the subject matter described herein in any way. Moreover, the above and/or proceeding embodiments may be combined in any suitable combination to provide further embodiments. Other features, aspects, and advantages of the subject matter described herein will become apparent from the following Detailed Description of Embodiments, Brief Description of Figures, and Claims.

### BRIEF DESCRIPTION OF FIGURES

Aspects, features and advantages of embodiments of the present disclosure will become apparent from the following detailed description of embodiments in reference to the appended drawings in which like numerals denote like elements.

FIG. 1 is a block system diagram showing an embodiment system for preparation of a beverage or foodstuff or a precursor thereof.

FIG. 2 is a block system diagram showing an embodiment machine of the system of FIG. 1.

FIG. 3 is an illustrative diagram showing an embodiment fluid conditioning system of the machine of FIG. 2.

FIGS. 4A and 4B are illustrative diagrams showing a schematic embodiment container processing system of the machine of FIG. 2.

FIG. 5 is a block diagram showing embodiment control electrical circuitry of the machine of FIG. 2.

FIG. 6 is an illustrative diagram showing a schematic embodiment container of the system of FIG. 1.

FIG. 7 is flow diagram showing an embodiment preparation process, which is performed by the system of FIG. 1.

FIG. 8 is a side view showing an embodiment storage portion of the container of FIG. 6.

FIG. 9 is a side cross-sectional view showing the storage portion of FIG. 8 though section lines A-A.

FIGS. 10A and 10B are respectively a top and a bottom perspective view showing the storage portion of FIG. 8.

FIG. 11 is a detail view showing the flange-like rim of the storage portion of FIG. 8.

FIG. 12 is a side cross-sectional view showing the cross-section of the storage portion of FIG. 9 and cross-section of a container holding portion of the system of FIG. 1.

FIG. 13 is a side cross-sectional view showing a portion of the storage portion of FIG. 9 stacked with a corresponding container.

FIGS. 14A and 14B are cross-section side view of two containers according to the invention having different sizes and forming a set of containers.

### DETAILED DESCRIPTION OF EMBODIMENTS

Before describing several embodiments of the system, it is to be understood that the system is not limited to the details of construction or process steps set forth in the following description. It will be apparent to those skilled in the art having the benefit of the present disclosure that the system is capable of other embodiments and of being practiced or being carried out in various ways.

The present disclosure may be better understood in view of the following explanations:

As used herein, the term “machine” may refer to an electrically operated device that: can prepare, from a precursor material, a beverage and/or foodstuff, or can prepare, from a pre-precursor material, a precursor material that can be subsequently prepared into a beverage and/or foodstuff. The machine may implement said preparation by one or more of the following processes: dilution; heating; pressurisation; cooling; mixing; whisking; dissolution; soaking; steeping; extraction; conditioning; infusion; grinding, and other like process. The machine may be dimensioned for use on a work top, e.g. it may be less than 70 cm in length, width and height. As used herein, the term “prepare” in respect of a beverage and/or foodstuff may refer to the preparation of at least part of the beverage and/or foodstuff (e.g. a beverage is prepared by said machine in its entirety or part prepared to which the end-user may manually add extra fluid prior to consumption, including milk and/or water).

As used herein, the term “container” may refer to any configuration to contain the precursor material, e.g. as a single-serving, pre-portioned amount. The container may have a maximum capacity such that it can only contain a single-serving of precursor material. The container may be single use, e.g. it is physically altered after a preparation process, which can include one or more of: perforation to supply fluid to the precursor material; perforation to supply the beverage/foodstuff from the container; opening by a user to extract the precursor material. The container may be configured for operation with a container processing unit of the machine, e.g. it may include a flange for alignment and directing the container through or arrangement on said unit. The container may include a rupturing portion, which is arranged to rupture when subject to a particular pressure to deliver the beverage/foodstuff. The container may have a membrane for closing the container. The container may have various forms, including one or more of: frustoconical; cylindrical; disk; hemispherical, and other like form. The container may be formed from various materials, such as metal or plastic or wood pulp based a combination thereof. The material may be selected such that it is: food-safe; it can withstand the pressure and/or temperature of a preparation process. The container may be defined as a capsule, wherein a capsule may have an internal volume of 20-100 ml. The capsule includes a coffee capsule, e.g. a Nespresso® capsule (including a Classic, Professional, Vertuo, Dolce Gusto or other capsules).

As used herein, the term “external device” or “external electronic device” or “peripheral device” may include electronic components external to the machine, e.g. those arranged at a same location as the machine or those remote from the machine, which communicate with the machine over a computer network. The external device may comprise a communication interface for communication with the machine and/or a server system. The external device may comprise devices including: a smartphone; a PDA; a video game controller; a tablet; a laptop; or other like device.

As used herein, the term “server system” may refer to electronic components external to the machine, e.g. those arranged at a remote location from the machine, which communicate with the machine over a computer network. The server system may comprise a communication interface for communication with the machine and/or the external device. The server system can include: a networked-based computer (e.g. a remote server); a cloud-based computer; any other server system.

As used herein, the term “system” or “beverage or foodstuff preparation system” may refer to the combination of any two of more of: the beverage or foodstuff preparation machine; the container; the server system, and the peripheral device.

As used herein, the term “beverage” may refer to any substance capable of being processed to a potable substance, which may be chilled or hot. The beverage may be one or more of: a solid; a liquid; a gel; a paste. The beverage may include one or a combination of: tea; coffee; hot chocolate; milk; cordial; vitamin composition; herbal tea/infusion; infused/flavoured water, and other substance. As used herein, the term “foodstuff” may refer to any substance capable of being processed to a nutriment for eating, which may be chilled or hot. The foodstuff may be one or more of: a solid; a liquid; a gel; a paste. The foodstuff may include yoghurt; mousse; parfait; soup; ice cream; sorbet; custard; smoothies; other substance. It will be appreciated that there is a degree of overlap between the definitions of a beverage and foodstuff, e.g. a beverage can also be a foodstuff and thus a machine that is said to prepare a beverage or foodstuff does not preclude the preparation of both.

As used herein, the term “precursor material” may refer to any material capable of being processed to form part or all of the beverage or foodstuff. The precursor material can be one or more of a: powder; crystalline; liquid; gel; solid, and other. Examples of a beverage forming precursor material include ground coffee; milk powder; tea leaves; coco powder; vitamin composition; herbs, e.g. for forming a herbal/infusion tea; a flavouring, and; other like material. Examples of a foodstuff forming precursor material include: dried vegetables or stock as anhydrous soup powder; powdered milk; flour based powders including custard; powdered yoghurt or ice-cream, and; other like material. A precursor material may also refer to any pre-precursor material capable of being processed to a precursor material as defined above, i.e. any precursor material that can subsequently be processed to a beverage and/or foodstuff. In an example, the pre-precursor material includes coffee beans which can be ground and/or heated (e.g. roasted) to the precursor material.

As used herein, the term “fluid” (in respect of fluid supplied by a fluid conditioning system) may include one or more of: water; milk; other. As used herein, the term “conditioning” in respect of a fluid may refer to changing a physical property thereof and can include one or more of the following: heating or cooling; agitation (including frothing via whipping to introduce bubbles and mixing to introduce turbulence); portioning to a single-serving amount suitable for use with a single serving container; pressurisation e.g. to a brewing pressure; carbonating; fliting/purifying, and other conditioning process.

As used herein, the term “processing unit” may refer to an arrangement that can process precursor material to a beverage or foodstuff. It may refer to an arrangement that can process a pre-precursor material to a precursor material.

As used herein, the term “container processing unit” may refer to an arrangement that can process a container to derive an associated beverage or foodstuff from a precursor material. The container processing unit may be arranged to process the precursor material by one of more of the following: dilution; heating; cooling; mixing; whisking; dissolution; soaking; steeping; extraction; conditioning; pressurisation; infusion, and: other processing step. The container processing unit may therefore implement a range of units depending on the processing step, which can include: an extraction unit (which may implement a pressurised and/or a thermal, e.g. heating or cooling, brewing process); a mixing unit (which mixes a beverage or foodstuff in a receptacle for end user consumption therefore; a dispensing and dissolution unit (which extracts a portion of the precursor material and processes by dissolution and dispenses it into a receptacle), and: other like unit.

As used herein, the term “preparation process” may refer to a process to prepare a beverage or foodstuff from a precursor material or to prepare a pre-precursor material from precursor material. A preparation process may refer to the processes electrical circuitry executes to control the container processing unit to process said precursor or pre-precursor material.

As used herein, the term “electrical circuitry” or “circuitry” or “control electrical circuitry” may refer to one or more hardware and/or software components, examples of which may include: an application specific integrated circuit (ASIC); electronic/electrical componentry (which may include combinations of transistors, resistors, capacitors, inductors etc); one or more processors; a non-transitory memory (e.g. implemented by one or more memory devices), that may store one or more software or firmware programs; a combinational logic circuit; interconnection of the aforesaid. The electrical circuitry may be located entirely at the machine or distributed between one or more of: the machine; external devices; a server system.

As used herein, the term “processor” or “processing resource” may refer to one or more units for processing, examples of which include an ASIC, microcontroller, FPGA, microprocessor, digital signal processor (DSP), state machine or other suitable component. A processor may be configured to execute a computer program, e.g. which may take the form of machine-readable instructions, which may be stored on a non-transitory memory and/or programmable logic. The processor may have various arrangements corresponding to those discussed for the circuitry, e.g. on-board machine or distributed as part of the system. As used herein, any machine executable instructions, or computer readable media, may be configured to cause a disclosed method to be carried out, e.g. by the machine or system as disclosed herein, and may therefore be used synonymously with the term method.

As used herein, the term “code” may refer to storage medium that encodes preparation information. The code may be an optically readable code, e.g. a bar code. The code may be formed of a plurality of units, which can be referred to as elements or markers.

As used herein, the term “preparation information” may refer to information related to a preparation process. Depending on the implementation of the processing unit said information may vary. The parameters that may be associated container processing unit that comprises a fluid processing system, can include one or more of: fluid pressure; fluid temperature; mass/volumetric flow rate; fluid volume; filtering/purification parameters for the fluid, and carbonation parameters for the fluid. More general parameters can include one or more of: container geometric parameters, e.g. shape or volume, and the type of precursor.

As used herein the term “cellulose pulp” refers to a pulp comprising cellulose fibres in a percentage ranging from 80% to 100% by weight. The term “cellulose fibres” refers to hard wood cellulose fibres, soft wood cellulose fibres, wheat fibres, corn fibres, bagasse fibres, bamboo fibres, hemp fibres, other similar vegetable or plant fibres, or a combination thereof. The length of the fibres is preferably comprised between 1 and 1000 microns, more preferably between 15 and 250 microns.

The terms “cellulose pulp-based material”, “cellulose-based layer” and the like refer to a material, layer and the like made at least of 80% in weight of cellulose pulp, and preferably is made at least of 90% in weight of cellulose pulp.

As used herein the term “wood pulp based” may refer to the or a portion of material forming the container which is one or more of: porous; fibrous; cellulosic; formed of cellulosic material; formed of natural cellulose pulp-based material; formed of reconstituted or regenerated cellulosic material; non-woven; is composed entirely of or is a composition of wood pulp and is wet formed. A thickness of the wood-based material may be 0.1 mm to 0.75 mm or about 0.5 mm. The density of the wood-based material may be 200-500 gsm.

As used herein the term “non-woven” may refer to a fabric-like material which is not woven or knitted. A non-woven material may be made from bonded together fibres. As used herein the term “porous” may refer to material configured with interstices to transmit water (or other liquid) therethrough. As used herein the term “fibrous” may refer to material comprised of fibres, which may be present in one or more of the material constituents. As used herein the term “cellulosic” or “cellulosic material” may refer to conventionally woody and/or non-woody materials, e.g. manila hemp, sisal, jute, bleached and unbleached soft wood and hard wood species. A cellulosic material may include a regenerated or reconstituted cellulose. As used herein the term “natural cellulosic material” may refer to conventionally woody materials, which are not regenerated. As used herein the term “reconstituted or regenerated cellulosic material” may refer natural cellulosic material subject to processing that comprises reconstitution or regeneration, examples include rayon and lyocell. As used herein the term “wood pulp” may refer to a lignocellulosic fibrous material, which may be prepared by mechanical or chemical separation of cellulose fibres from one or more of wood, fibre crops, paper or rags. As used herein the term “wet formed” may refer to a process of forming from an aqueous solution of fibres. The aqueous solution of fibres may be heated and pressed in a mould to set the material and remove water therefrom.

### General System Description

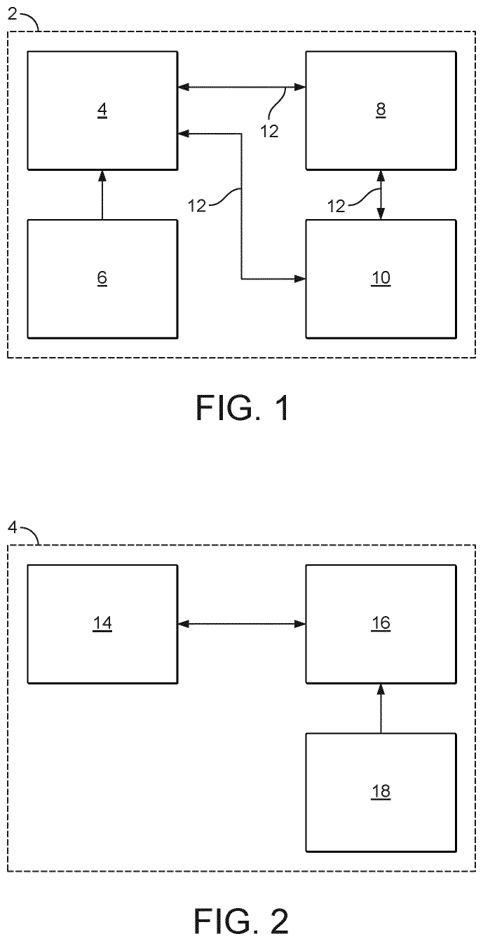

Referring to FIG. 1, the system 2 comprises a machine 4, a container 6, server system 8 and a peripheral device 10. The server system 8 is in communication with the machine 4 via a computer network 12. The peripheral device 10 is in communication with the machine 4 via the computer network 12.

In variant embodiments, which are not illustrated: the peripheral device and/or server system is omitted.

Although the computer network 12 is illustrated as the same between the machine 4, server system 8 and peripheral device 10, other configurations are possible, including: a different computer network for intercommunication between each device: the server system communicates with the machine via the peripheral device rather than directly. In a particular example: the peripheral device communicates with the machine via a communication interface, e.g. with a Bluetooth™ protocol, and the server system communicates with the machine via a via a wireless interface, e.g. with a IEE 802.11 standard, and also via the internet.

### [Machine]

Referring to FIG. 2, the machine 4 comprises: a processing unit 14 for processing the precursor material; electrical circuitry 16, and a code reading system 18.

The electrical circuitry 16 controls the code reading system 18 to read a code (not illustrated in FIG. 2) from the container 6 and determine preparation information therefrom. The electrical circuitry 16 uses the preparation information to control the processing unit 14 to execute a preparation process, in which the precursor material is process to a beverage or foodstuff or a precursor thereof.

In variant embodiments, which are not illustrated: the code and code reading system is omitted and the machine executes one or more preparation processes stored on an electronic memory of the electrical circuitry.

### [First Example of Processing Unit]

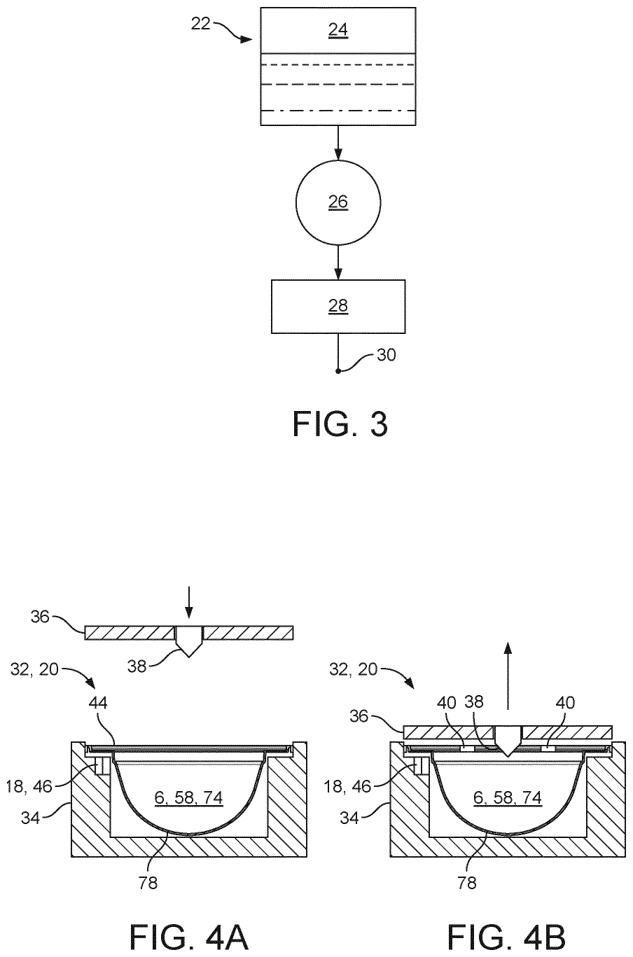

Referring to FIGS. 3 and 4, in a first example of the processing unit 14, said unit comprises a container processing unit 20 and a fluid conditioning system 22.

The container processing unit 20 is arranged to process the container 6 to derive a beverage or foodstuff from precursor material (not illustrated) therein. The fluid conditioning system 22 conditions fluid supplied to the container processing unit 20. The electrical circuitry 16 uses the preparation information read from the container 6 to control the container processing unit 20 and the fluid conditioning system 22 to execute the preparation process.

### [Fluid Conditioning System]

Referring to FIG. 3, the fluid conditioning system 22 includes a reservoir 24; pump 26; heat exchanger 28, and an outlet 30 for the conditioned fluid. The reservoir 24 contains fluid, typically sufficient for multiple preparation processes. The pump 26 displaces fluid from the reservoir 24, through the heat exchanger 26 and to the outlet 30 (which is connected to the container processing unit 20). The pump 26 can be implement as any suitable device to drive fluid, including: a reciprocating; a rotary pump; other suitable arrangement. The heat exchanger 28 is implemented to heat the fluid, and can include: an in-line, thermo block type heater; a heating element to heat the fluid directly in the reservoir; other suitable arrangement.

In variant embodiments, which are not illustrated: the pump is omitted, e.g. the fluid is fed by gravity to the container processing unit or is pressurised by a mains water supply; the reservoir is omitted, e.g. water is supplied by a mains water supply; the heat exchanger is arranged to cool the fluid, e.g. it may include a refrigeration-type cycle heat pump); the heat exchanger is omitted, e.g. a mains water supply supplies the water at the desired temperature; the fluid conditioning system includes a filtering/purification system, e.g. a UV light system, a degree of which that is applied to the fluid is controllable; a carbonation system that controls a degree to which the fluid is carbonated.

### [Container Processing Unit]

The container processing unit 20 can be implemented with a range of configurations, as illustrated in examples 1˜4 below:

Referring to FIGS. 4A and 4B, a first example of the container processing unit 20 is for processing of a container arranged as a capsule 6 (a suitable example of a capsule is provided in FIG. 6, which will be discussed) to prepare a beverage. The container processing unit 20 is configured as an extraction unit 32 to extract the beverage from the capsule 6. The extraction unit 32 includes a container/capsule holding portion 34 and a closing member 36. The extraction unit 32 is movable to a capsule receiving position (FIG. 4A), in which the capsule holding portion 34 and the closing member 36 are arranged to receive a capsule 6. The extraction unit 32 is movable to a capsule extraction position (FIG. 4B), in which the capsule holding portion 34 and a closing member 36 form a chamber around the capsule 6, and the beverage can be extracted from the capsule 6. The extraction unit 32 can be actuator driven or manually movable between said positions.

The extraction unit 32 integrates in the capsule holding portion 34 an image capturing unit 46 which is part of the code reading system 18 disclosed in connection with FIG. 2. Hence, when the extraction unit 32 is in the capsule extraction unit (FIG. 4B), a code (not represented), coding for preparation information and located on the capsule 6, is red.

The outlet 30 of the fluid conditioning system 22 (FIG. 3) is arranged as an injection head and/or penetrator 38 to penetrate the container to form one or more inlets for injection of the conditioned fluid into the capsule 6 in the capsule extraction position. A beverage outlet 40 is arranged to capture the extracted beverage and convey it from the extraction unit 32 to the consumer cup (not represented).

In the present case, the extraction unit 32 is arranged to prepare a beverage by application of a conditioned fluid (generally water) at a low pressure (less than 8 bars) to the precursor material within the capsule 6 thanks to the inlet(s) formed by the penetrator 38. The capsule is spun at a given rotational speed (depending among other on the material precursor inside the capsule and/or on the desired sensory profile of the beverage to be obtained), and the beverage is extracted out of the capsule 6 by centrifugation. An example of a suitable aluminium capsule is a Nespresso® Vertuo capsule currently available on the market. A suitable capsule example is provided in EP 2594171 A1 and a suitable extraction process is provided in EP 2155019 A1, both references are incorporated herein by reference.

In a variant embodiment, which is not illustrated, the extraction unit is arranged to prepare a beverage by the application of pressurised (e.g. at 10-20 Bar), heated (e.g. at 50-98 degrees C.) fluid to the precursor material within the capsule. The pressure is increased over a predetermined amount of time until a pressure of a rupturing portion, which is the closing member of the capsule is exceeded, which causes rupture of said member and the beverage to be dispensed to the beverage outlet.

In a second embodiment, which is not illustrated, although the injection head and beverage outlet are illustrated as arranged respectively on the holding portion and closing member, they may be alternatively arranged, including: the injection head and beverage outlet are arranged respectively on the closing member and holding portion; or both on the same portion. Moreover, the extraction unit may include both parts arranged as a capsule holding portion, e.g. for capsules that are symmetrical about the flange, including a Nespresso® Professional capsule.

In a third example, (which is not illustrated) the capsule processing unit operates by dissolution of a beverage precursor that is selected to dissolve under high pressure and temperature fluid. The arrangement is similar to the extraction unit of the first and second example, however the pressure is lower and therefore a sealed extraction unit is not required. In particular, fluid can be injected into a lid of the capsule and a rupturing portion is located in a base of a storage portion of the capsule. An example of a suitable capsule is a Nespresso® Dolce Gusto capsule. Examples of suitable extraction units are disclosed in EP 1472156 A1 and in EP 1784344 A1, which are incorporated herein by reference.

In a fourth example, (which is not illustrated) the container processing unit is arranged as a mixing unit to prepare a beverage or foodstuff precursor that is stored in a container that is a receptacle, which is for end user consumption therefrom. The mixing unit comprises an agitator (e.g. planetary mixer or a spiral mixer or a vertical cut mixer) to mix and a heat exchanger to heat/cool the beverage or foodstuff precursor in the receptacle. A fluid supply system may also supply fluid to the receptacle. An example of such an arrangement is provided in WO 2014067987 A1, which is incorporated herein by reference.

### [Control Electrical Circuitry]

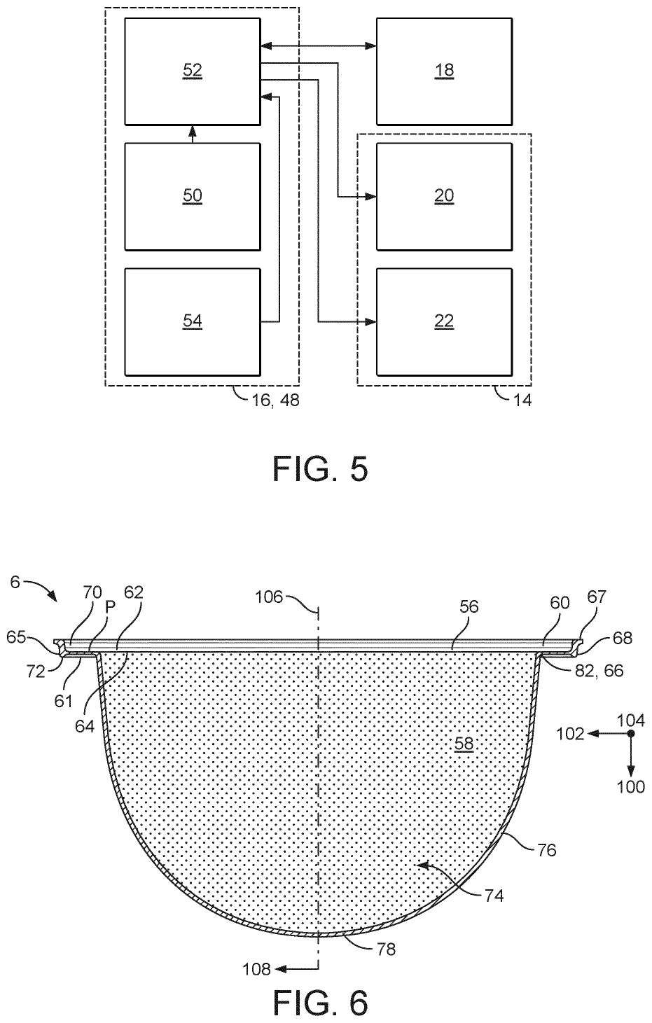

Referring to FIG. 5, the electrical circuitry 16 is implemented as control electrical circuitry 48 to control the processing unit 14 to execute a preparation process. In the embodiment of FIG. 5, for illustrative purposes, the processing unit 14 is exemplified as the first example, which comprises a container processing unit 20 and a fluid supply unit 22.

The electrical circuitry 16, 48 at least partially implements (e.g. in combination with hardware) an: input unit 50 to receive an input from a user confirming that the machine 4 is to execute a preparation process; a processor 52 to receive the input from the input unit 50 and to provide a control output to the processing unit 14, and a feedback system 54 to provide feedback from the processing unit 54 during the preparation process, which may be used to control the preparation process.

The input unit 50 is implemented as a user interface, which can include one or more of: buttons, e.g. a joystick button or press button; joystick; LEDs; graphic or character LDCs; graphical screen with touch sensing and/or screen edge buttons; other like device; a sensor to determine whether a container has been supplied to the machine by a user.

The feedback system 54 can implement one or more of the following or other feedback control-based operations:
a flow sensor to determine a flow rate/volume of the fluid to the outlet 30 (shown in FIG. 3) of the fluid supply system 22, which may be used to meter the correct amount of fluid to the container 6 and thus regulate the power to the pump 26;
a temperature sensor to determine a temperature of the fluid to the outlet 30 of the fluid supply unit 22, which may be used to ensure the temperature of fluid to the container 6 is correct and thus regulate the power to the heat exchanger 28);
a level sensor to determine a level of fluid in the reservoir 24 as being sufficient for a preparation process;
a position sensor to determine a position of the extraction unit 32 (e.g. a capsule extraction position or a capsule receiving position).

It will be understood that the electrical circuitry 16, 48 is suitably adapted for the other examples of the processing unit 14, e.g.: for the second example of the container processing system the feedback system may be used to control speed of rotation of the capsule.

### [Container]

Referring to FIG. 6, a container 6, that is for use with the first example of the processing unit 14 comprises the container arranged as a capsule 6.

The capsule is preferably a single-use or refillable capsule. The capsule contains a dose of precursor material, for example coffee, for the preparation of a coffee beverage.

The capsule 6 includes: a closing member 56; a container body designed as a storage portion 58, and an annular flange-like rim 60 surrounding the capsule 6. The details of the flange-like rim 60 are not presented in FIG. 6 and will be detailed in connection with FIG. 8 and followings.

A local container coordinate axis includes a depth direction 100, longitudinal direction 102, and a lateral direction 104. A rotational axis 106 extends in the depth direction 100 and defines a radial direction 108, which is in a plane defined by the longitudinal direction 102, and the lateral direction 104.

The capsule 6 has a circular cross-section when viewed in the plane defined by the longitudinal direction 102, and the lateral direction 104, and preferably designed as being rotationally symmetric about central axis 106.

The closing member 56 is arranged in the plane defined by the longitudinal direction 102, and the lateral direction 104. The closing member 56 closes the storage portion 58 at the open end of the storage portion and comprises a flexible membrane. The closing member 56 has an exterior surface 62 that faces away from the storage portion 58 and an interior surface 64 that faces towards the storage portion 58.

The closing membrane 56 is made of a food grade material and forms a gas barrier layer. It may be made of an aluminum alloy, of plastic (PP, EVOH . . . ), of a laminate of plastic and aluminum alloy or of a paper-based material having oxygen barrier properties or any suitable material, preferably compostable and/or biodegradable. The closing membrane is usually of a thickness between 10 and 250 microns.

The flange-like rim 60 is arranged to interconnect the storage portion 58 and closing member 56 to hermetically seal the precursor material. The flange-lie rim 60 is arranged as an annular ring, which extends in the radial direction 108 from an interior edge 66 to an exterior edge 67. The flange-like rim 60 comprises a flat segment 61 which is arranged in the plane P defined by the longitudinal direction 102, and the lateral direction 100. The flange-like rim 60 presents an upper surface 70 which is connected by an adhesive (or any sealing means) to a periphery of the interior surface 64 of the closing member 56. A lower surface 72 of the flange-like rim faces towards the storage portion 58.

In the present disclosure, the flange-like rim 60 is at least partially made of cellulose pulp-based material, for example of wood-pulp based material.

The storage portion 58 includes a closed bottom end forming a base 78 and an open that define a cavity 74 for storage of the precursor material (not illustrated). The cavity 74 includes a sidewall 76 connecting the open end and the base 78. The sidewall 76 extends principally in the depth direction 100 from the base 78 to a proximal edge 82 connected to the flange-like rim 60, wherein proximal and distal are defined relative the base 78. The sidewall 76 is in the form of a convex portion from the base 78 to the proximal edge 82. As mentioned, the distal edge 82 of the sidewall 76 adjoins the interior edge 66 of the flange-like rim 60. The storage portion 58 and flange-like rim 60 are integrally formed.

The capsule 6 has a diameter of 2-8 cm and an axial length of 2-8 cm. Constructional, manufacturing and/or (beverage) extraction details of containers and/or closing members are for instance disclosed in EP 2155021, EP 2316310, EP 2152608, EP2378932, EP2470053, EP2509473, EP2667757 and EP 2528485.

In variant embodiments, which are not illustrated: the capsule may have other cross-section shapes, including square, other polygons, or elliptical; the closing member may be rigid or other non-membrane formation; the flange is alternatively connected to the upper surface of the closing member, e.g. by crimping; the sidewall is alternatively arranged, including with the reverse taper or is aligned to the depth direction, or is curved; the base is alternatively arranged, including with as flat or curved; the flange portion is connected to the storage portion rather than being integrally formed; the closing member is arranged as a storage portion, e.g. it comprises a cavity, and; the flange portion is omitted, e.g. the closing member connects directly to the storage portion.

Referring to FIGS. 4A and 4B, the closing member 56, closing the storage portion 58 is perforated by a penetrator 38 to form inlets for injection of conditioned fluid into the cavity 74 as will be discussed. The penetrator 38 may be arranged as separate blades or a blade than integrates the injector.

Further referring to FIGS. 4A and 4B, the flange-like rim 60 comprises a code zone on the side facing the storage portion 58.

In the disclosed embodiments, the closing member 56 is additionally perforated by one of more needles 41 to form outlet openings 40 for the prepared beverage to exit the capsule 6.

### [Preparation Process]

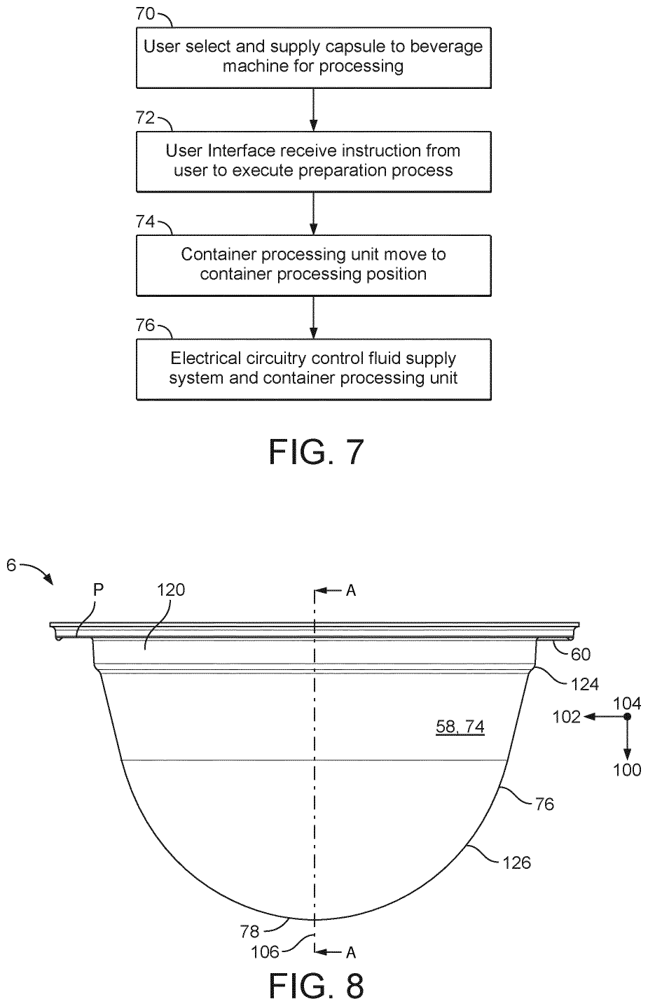

Referring to FIG. 7, the execution of a process for preparing a beverage/foodstuff from precursor material is illustrated:

Block 70: a user supplies a container 6 to the machine 4.

Block 72: the electrical circuitry 16 (e.g. the input unit 50 thereof) receives a user instruction to prepare a beverage/foodstuff from precursor, and the electrical circuitry 16 (e.g. the processor 52) initiates the process.

Block 74: the electrical circuitry 16 controls the processing unit 14 to process the container (e.g. in the first example of the container processing unit 20, the extraction unit 32 is moved from the capsule receiving position (FIG. 4A) to the capsule extraction position (FIG. 4B).

Block 76: the electrical circuitry 16, based on preparation information either read from a code on the container or stored on a memory, executes the preparation process by controlling the processing unit 14. In the first example of the processing unit this comprises: controlling the fluid conditioning system 22 to supply fluid at a temperature, pressure, and time duration specified in the preparation information to the container processing unit 20.

The electrical circuitry 16 subsequently controls the container processing unit 20 to move from the capsule extraction portion though the capsule ejection position to eject the container 6 and back to the capsule receiving position.

In variant embodiments, which are not illustrated: the above blocks can be executed in a different order, e.g. block 72 before block 70; some block can be omitted, e.g. where a machine stores a magazine of capsules block 70 can be omitted.

As part of the preparation process, the electrical circuitry 16 can obtain additional preparation information via the computer network 12 from the server system 8 and/or peripheral device 10 using a communication interface (not illustrated) of the machine.

### [Container Flange-Like Rim]

Referring to FIGS. 8 to 12, the container arranged as a capsule 6 associated with the embodiment of FIG. 6 includes the annular flange-like rim 60 that is formed of a cellulose-based material and more specifically of a wood pulp-based material (as previously defined).

In the proposed embodiment the storage portion 58 (forming the container body) is also formed of a wood pulp-based material and is integral with the annular flange-like rim 60. Hence the whole capsule 6 is made of wood pulp-based material.

As disclosed the flange-like rim 60 extends outwardly from the container body forming the storage portion 58 and connects the storage portion and the closing member. The flange-like rim 60 extends outwardly in horizontal direction to a width W which is comprised between 2 and 5 mm.

The flange-like rim 60 has a flat segment 61 and comprises an annular force ring 62.

Referring to FIGS. 4A and 4B, a code zone (not represented) is located on the flat segment 61 of the flange-like rim 60. Because of the location of the image capturing unit 46 (as part of the code reading system 18 of the extraction unit 32), the code zone is located on the side facing the storage portion 58 that corresponds to the lower surface 72 of the flange-like rim 60.

The annular force ring 62 protrudes to the exterior of the capsule from the flange-like rim 60. Hence the capsule 6 is circumferentially surrounded by the annular force ring 62 protruding to the exterior of the capsule 6.

The capsule 6 comprising the outwardly protruding force ring 62 comprises an outer diameter OD which preferably lies between 50 and 70 mm. In a preferred example, the outer diameter OD is comprised between 52 and 61 mm.

The annular force ring 62 additionally extends upwardly from the flange-like rim 60 and is designed to engage with the preparation machine 4.

In more details, the annular force ring 62 constitutes an engagement member which is designed to be engaged by the extraction unit 32 of the preparation machine 4, more precisely by a dedicated pressing surface (not represented) of the closing member 36 of the extraction unit when the capsule is positioned in the container holding 34 portion.

The annular force ring 62 is, along with the storage portion 58 and as part of the flange-like rim 60, made of cellulose pulp-based material.

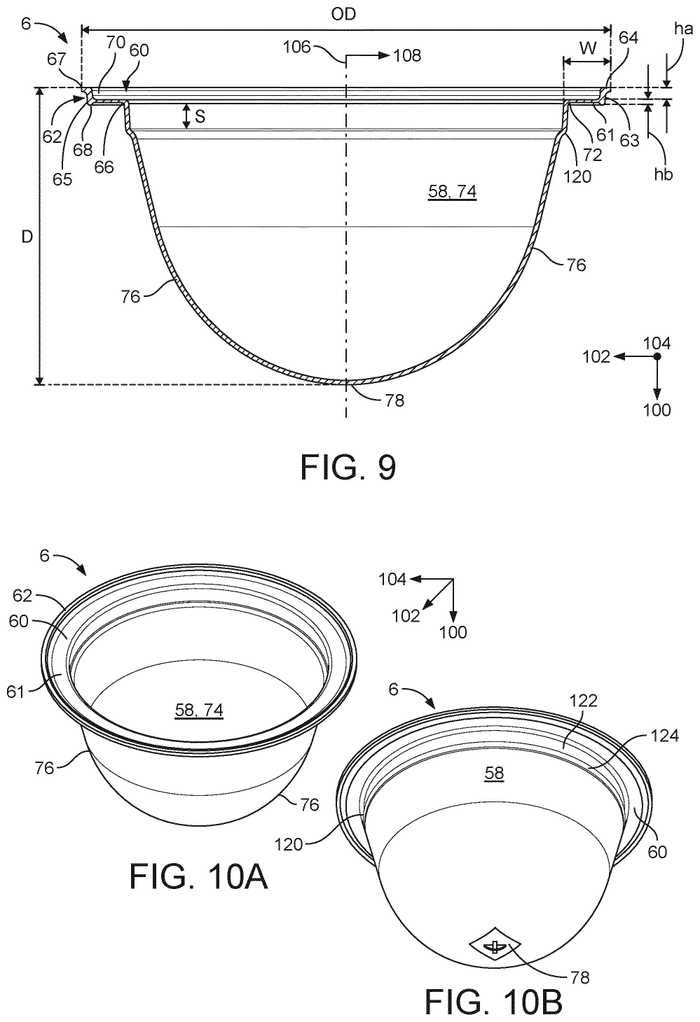

As represented the annular force ring 62 is of essentially S-shaped when seen in transversal cross-section as in FIG. 9. It mainly extends in a direction opposite the storage portion and beyond a plan P containing the flat segment 61 of the rim.

The force ring 62 comprises a first portion 63, a second portion 64 and a third portion 65.

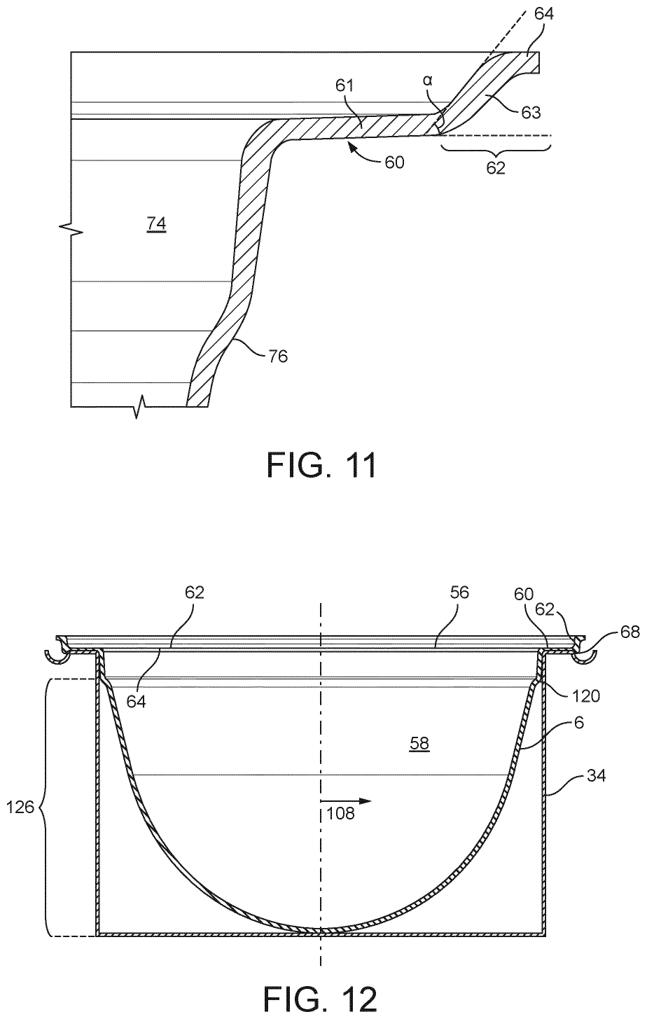

The first portion 63 extends outwardly from the flat segment 61 of the flange-like rim and forms with said flat segment 61 an angle α (as represented in FIG. 11) comprised between 20° and 85°. The value of angle α may be limited to manufacturing constrains applying during the production of the wood-pulp based flange-like rim 60.

The second portion 64 extends from the first portion 63 on the side opposite the flat segment 61. Some limitation on the value of angle α may apply due to the manufacturing process of the wood-pulp based flange-like rim 60.

In the presently proposed embodiment, the second part 64 of the force ring 62 comprises a flat extension however a curved extension may be envisaged.

The first 63 and second 64 portions of the force ring extend in a direction opposite the storage portion 58 and beyond a plan P containing the flat segment 61 of the flange-like rim 60, by an upward distance of extension ha from said plan P.

The upward distance of extension ha lies between 0.5 and 2 mm. In the proposed embodiment it preferably lies between 1 and 1.8 mm.

The force ring 62 also comprises a third portion 65 extending between the flat segment 61 of the flange-like rim 60 and the first portion 63 of the force ring 62.

The third portion 65 of the force ring 62 here extends in the direction of the container body below the plan P containing the flat segment 61 of the flange-like rim 60, by a downward distance of extension hb from said plan P. The downward distance of extension hb extending below the plan P is shorter than the upward distance of extension ha extending above the plan P.

The third portion 65 is intended to interact with the preparation machine 4. In details, it forms centering means for the container when the capsule 6 is positioned in the container holding portion 34 of the preparation machine 4. The third portion 65 also avoids possible bending and/or deformation and/or breaking of the flange-like rim 60 (including the force ring 62) during the extraction process.

As presented in FIGS. 9 and 12, the third portion 65 is in the form of a bump 68 which interacts with the container holding portion 34, at the location of the bump 68, when the container 6 is in place in the container holding portion 34.

As previously mentioned, the first 63, second 64 and third 65 portions of the force ring 62 are sections of the flange-like rim and integral with the flange-like rim 60.

In the capsule 6, the density of the wood-based material of the flange-like rim 60, including the annular force ring, is comprised between 200 and 500 gsm. However, the density of the material may vary for the different elements of the flange-like rim 60 depending on the manufacturing process.

In connection with the capsule 6 made of wood-based pulp of FIG. 11, the different elements of the flange-like rim 60, including the flat segment 61 and the first 63, second 64 and third portion 65 of the annular force ring 62 have substantially the same thickness. The thickness is between, 40 and 600 microns.

In the capsule of FIG. 9; where the flat segment 61 of the flange-like rim 60 has undergone a local compression (which will be explained in more detail in a next section of the present disclosure), the flat-segment has a thickness that is comprised between 150 and 400 microns whereas the other parts of the flange-like rim 60, for example the force ring 62, have a thickness between 400 and 600 microns.

In a variant embodiment, which is not illustrated, the annular force ring extends in the direction of the storage portion and beyond the plan P containing the flat segment of the flange-like rim, by a distance of extension hc (not represented) from said plan P.

It could also be envisaged that in a variant embodiment that is not represented that the flange-like rim is free of any downward extension below the plan P.

In other variant embodiments, which are not illustrated, only part of the storage portion 58 (forming the container body) may be formed of the wood pulp-based material, e.g. only the base or a base region as defined herein.

A method of forming the flange-like rim and/or storage portion can include wet forming one or both of the flange-like rim and storage portion and pressing e.g. via the same mould/press.

At block 74, as shown in FIG. 7, the previously described preparation process can be implemented by: arranging the container 6 in the container holding portion 34 of the processing unit 14 of a machine 4. The container 6 can be penetrated by the penetrator 38 (shown in FIGS. 4A and 4B) to form inlets. The penetrator 38 comprises one or more, for example three perforation elements. The container 6 is then processed by the extraction unit 32.

### [Container Flange-Like Rim Function]

As disclosed in connection with FIGS. 6, 8 to 12, the capsule 6 may be conceived to be extracted using a centrifugal extraction process as, for example, disclosed in EP 2155019 A1, which is incorporated herein by reference. In such extraction process, used in the Nespresso® Vertuo Line, the flange-like rim 60 of the capsule 6 and more specifically its outer extension (annular force ring 62) is interacting with the preparation machine and may play a flow restriction or flow restriction valve function. This is disclosed in EP2667757 A1, which is incorporated herein by reference.

In detail, the force ring 62 which extends upwardly from the flat segment 61 of the flange-like rim 60 is designed to form part of a valve means for selectively blocking and/or restricting the flow of the centrifugal liquid coming out of the capsule 6 during the extraction process.

More specifically, the force ring 62 preferably extends upwardly from the plan P containing the flat segment 61 to a height ha (defined as upward distance of extension) between 0.5 and 2.5 mm, in order to adapt the back-pressure exerted by a dedicated pressing surface of a beverage production device to be used in conjunction with the present capsule.

Thereby, it is to be understood that the greater the measure of height ha (upward distance of extension) is, the higher is the back pressure exerted by the pressing surface onto the force ring 62 of the capsule; therefore, the higher the overcoming pressure of the centrifuged liquid must be, to open the valve and maintained it opened.

In a preferred embodiment, height ha of the force ring 62 of the capsule 6 is preferably between 1 and 1.8 mm high in order to exert a high back pressure onto the capsule 6 which will resolve in a high crema quality and quantity, but as well in a proper flow rate.

The conceived annular force ring 62 provides a rigid engagement portion when being engaged by the dedicated pressing surface (not represented) of the closing member 36 of the extraction unit 32 of the preparation machine 4 thereby forming stable valve means.

Hence as disclosed, the flange-like rim portion 60 has several functions: it has a valve, a centering function, anti-deformation function and when holding a code, a recognition means support function.

### [Compression of Flange-Like Rim]

Referring to FIGS. 8 to 12, the container arranged as a capsule 6 associated with the embodiment of FIG. 6 includes the annular flange-like rim 60 formed of a cellulose-based material and more specifically of a wood pulp-based material (as previously defined).

All or at least part of the flange-like rim 60 and more specifically of the flat segment 61 of the flange-like rim 60 may be compressed for better interaction with the preparation machine.

Additionally, it provides an improved surface to carry a code (not represented) on the lower surface 72 of the flange-lie rim 60 at the location of the flat segment 61.

In particular, pressing process with or without heating may be applied to reduce a thickness of a flange-like rim 60 when formed of a wood pulp-based material so that the flat segment 61 has a comparable thickness to that of a container formed of conventional materials (e.g. aluminium) to ensure compatibility with existing machines. The pressing process (with optional heat process) may also provide a more consistent surface to act as a substrate for the code, which may improve code reading reliability. In such an example the preparation process can include a step of reading the code to extract preparation information therefrom. The step of reading the code can include rotating the code relative a code reader, e.g. by rotating the container about the axis of rotation 106. A Nespresso® Vertuo® container may implement such a flange-like rim portion.

The pressing process applies on the flat segment of the flange-like rim a pressure between 1×10⁵-1×10⁷ Pa to compress the wood pulp-based material. The pressing process can optionally be completed with a heating process using temperatures between 50- and 300-degrees C. It will be understood that any suitable pressure and temperature combination may be selected. The pressing force can be applied for 5-60 seconds.

During the proposed pressing process, a code could be applied by engraving.

In variant embodiments, alternative treatments are implemented including applying a coating, and scoring to reduce material cross-section. As used herein the term “applying a coating” may refer to the application of a coating to the wood pulp-based material to close pores/interstices between the fibres and/or to act as a barrier. This may provide reduced water absorption, which may be advantageous for the reasons previously given.

### [Container Shoulder]

Referring to FIGS. 8, 9, 11, 12 and 13, the capsule 6 presents sidewalls 76 comprising a shoulder 120, which is arranged to adjoin the flange-like rim 60. The shoulder 120 extends in the depth direction 100 from the lower surface 72 of the flange-like rim 60 to a rim 122. The shoulder 120 defines a linear outer surface 124 between the flange-like rim 60 and rim 122. The outer surface 124 tapers with decreasing radial extent from the flange portion 60 to the rim 122. Said tapering may facilitate more convenient location of the container 6 in the container holding portion 34. The rim 122 is curved.

In variant embodiment, which are not illustrated: the shoulder is separated from the flange-like rim by a gap; the outer surface is alternatively profiled, including as curved or is aligned in the depth direction, and the rim is alternatively profiled, including as a step or linear ramp.

The outer surface 124 has a greater radial extent than a void defining region 126 of the sidewalls 76. The void defining region 126 of the sidewalls 76 extends for the remainder of the sidewalls 76 from the shoulder 120 to the base 78.

In variant embodiment, which are not illustrated: a lower portion of the sidewalls includes a second shoulder that engages with the container holding portion, such that the void defining region of the sidewalls does not extend for the remainder of the sidewalls.

Referring to FIG. 12, the shoulder 120 is arranged to engage an upper region of the container holding portion 34 of the processing unit 14 of the machine 4 with the void defining region 126 positioned separated in the radial direction 108 from the container holding portion 34 to define a void 128 therebetween.

The shoulder 120 is arranged to correspond in shape to the upper region of the container holding portion 34 such that the entire outer surface 124 is engaged for improved accuracy in positioning the container 6 in the container holding portion of the preparation machine. At the end of the extraction process, the container 6 can be easily ejected from the container holding portion 34 whilst the void region 128 is maintained.

In variant embodiment, which are not illustrated: the outer surface includes grooves or other surface discontinuities that do not engage the container holding portion for reduced sticking.

The shoulder 120 has a depth distance S between the lower surface 72 of the flange-like rim 60 and an intersection of the rim 122 and the outer surface 124 that is of less than about 15% of the total depth D of the storage portion 58 (as defined previously).

In variant embodiment, which are not illustrated: S is alternatively dimensioned including less than 40% or 30% of D, and a minimum distance for S can be greater than 5% or 10% of D.

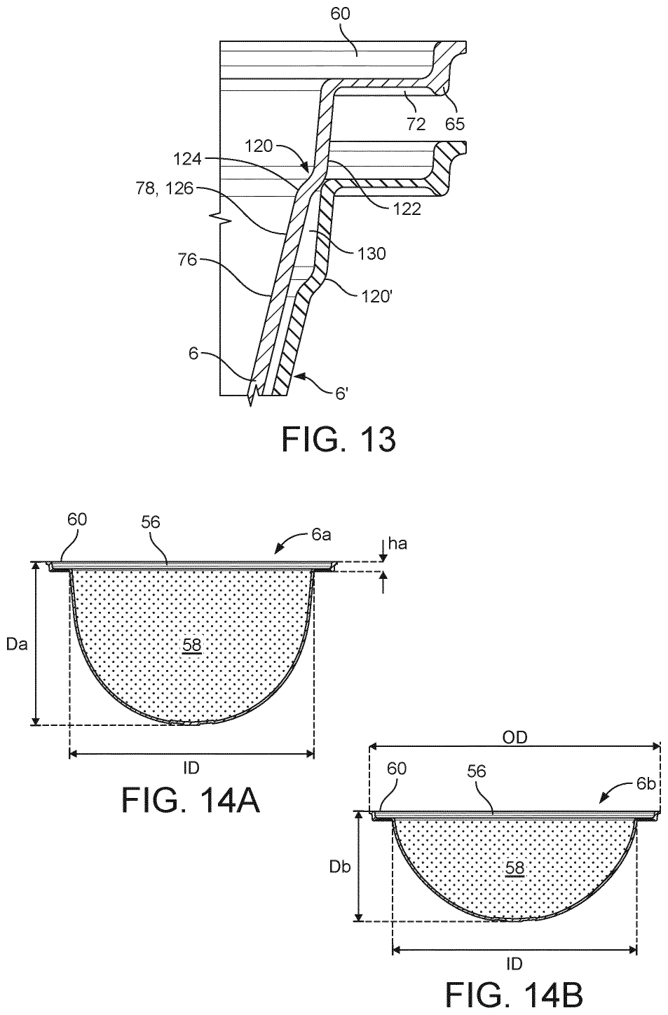

Referring to FIG. 13, the container 6 is arranged to be stacked partially within a second corresponding in shape container 6′. The rim 122 of the shoulder 120 of the container 6 engages the flange-like rim 60′ (including a proximal portion of the storage portion) of the second container 6′. A part of the void defining region 126 of the sidewall 76 of the container 6 that is adjacent the shoulder 120′ of the second container 6′ is distal said shoulder 120′ to define a void 130. The remainder of the void defining region 126 of the sidewall 76 of the container 6 may also define the void 130. With such an arrangement, containers prior to filling may be stacked with reduced sticking.

At block 74, as shown in FIG. 7, the previously described preparation process can be implemented by: arranging the container 6 in the container holding portion 34 of the processing unit 14 of a machine 4 and engaging the shoulder 120 of the sidewall 76 of the container 6 with the container holding portion 34 to position the void defining region 126 of the sidewall 76 away from the container holding portion 34 to define the void region 128.

A method of filling the container 6 with precursor material (not shown) comprises: arranging the storage portion 58 of the container 6 in a container holding portion (not shown, although it can be envisaged as being similar to the container holding portion 34 of the machine 4) of a filling machine (also not shown). This step can therefore be implemented as discussed for the container holding portion 34. The storage portion 58 may be supplied to the filling machine with two or more containers stacked in the previously described arrangement. After filling the storage portion 58 can be closed with the closing member 56.

A method of forming the storage portion can include wet forming the storage portion and shoulder concurrently, e.g. via the same mould/press. Alternatively the shoulder may be subsequently pressed into the storage portion.

### [Set of Containers of Different Size]

Referring to FIGS. 14A and 14B, a set of capsules 6a, 6b is presented. Each capsule 6a, 6b of the set is similar to the capsule 6 disclosed in connection with the previous figures and includes: a closing member 56; a container body designed as a storage portion 58, and an annular flange-like rim 60 as previously disclosed.

The closing member 56 is connected to the flange-like rim portion 60 to form a seal of the storage portion 58.

The container body of the respective capsule 6a, 6b has a single convex storage portion of variable depth, respectively Da, Db as can be seen in the figures.

The flange-like rim 60 of the capsules 6a, 6b of the set has the same dimensions for all the capsules of the set to fit in the container holding portion 34 of the machine 4 previously disclosed. The flange-like rim 60 has the same arrangement, as disclosed in connection with FIGS. 6 and 8 to 13, for each capsule 6a, 6b of the set and will be engaged in a similar way by the extraction unit 32 (container holding portion 34 and closing member 36) of the preparation machine 4 and will provide the same valve function (as previously disclosed in the specifications).

The capsules 6a, 6b of the set comprise different volumes with the same insertion diameter ID. The insertion diameter ID is determined at the line of intersection between the lower surface 72 of the flange-like rim and the storage portion 58 at the location of the distal edge 82.

The capsule of FIG. 14A is a large volume capsule, whereas the capsule of FIG. 14B shows a smaller volume capsule. The volume difference between the small and large capsule is obtained by the varying depth Da, Db of the storage portion 58 (container body) of the capsules in the set. In particular, the depth of the storage portion 58 of the larger capsule 6a (FIG. 14A) is larger than the depth of the storage portion of the smaller capsule 6b (14B).

Additionally, the different containers of a set of containers may further comprise annular force ring with different upward distance of extension (ha1, ha2, ha3) from said plan (P), that differs for the different containers according to the type of extraction that is expected.

Small capsules containing a small amount of precursor material, like capsule 6b, contain an amount of precursor material that is smaller than the amount of precursor material contained in large capsules 6a. Taking the example of precursor material being coffee, a small capsule 6b is generally intended for delivery of a short coffee between 10 mL and 60 mL with an amount of ground coffee between 4 and 8 grams.

A large capsule 6a, is intended for delivery of a long-size coffee between 200 and 500 mL with an amount of coffee between 8 and 30 grams.

Capsules of intermediate size (not represented) may be defined for the delivery of a medium-size coffee between 60 and 120 mL with an amount of coffee between 6 and 15 grams. Additional intermediate sized capsules may be further defined. Examples of suitable capsule sets are disclosed in WO 2011/069830 A1.

In the present disclosure a set of two capsules have ben detailed, however, the set of capsules may be formed of more than two capsules of different size.

It will be appreciated that any of the disclosed methods (or corresponding apparatuses, programs, data carriers, etc.) may be carried out by either a host or client, depending on the specific implementation (i.e. the disclosed methods/apparatuses are a form of communication(s), and as such, may be carried out from either ‘point of view’, i.e. in corresponding to each other fashion). Furthermore, it will be understood that the terms “receiving” and “transmitting” encompass “inputting” and “outputting” and are not limited to an RF context of transmitting and receiving radio waves. Therefore, for example, a chip or other device or component for realizing embodiments could generate data for output to another chip, device or component, or have as an input data from another chip, device or component, and such an output or input could be referred to as “transmit” and “receive” including gerund forms, that is, “transmitting” and “receiving”, as well as such “transmitting” and “receiving” within an RF context.

As used in this specification, any formulation used of the style “at least one of A, B or C”, and the formulation “at least one of A, B and C” use a disjunctive “or” and a disjunctive “and” such that those formulations comprise any and all joint and several permutations of A, B, C, that is, A alone, B alone, C alone, A and B in any order, A and C in any order, B and C in any order and A, B, C in any order. There may be more or less than three features used in such formulations.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

Unless otherwise explicitly stated as incompatible, or the physics or otherwise of the embodiments, example or claims prevent such a combination, the features of the foregoing embodiments and examples, and of the following claims may be integrated together in any suitable arrangement, especially ones where there is a beneficial effect in doing so. This is not limited to only any specified benefit, and instead may arise from an “ex post facto” benefit. This is to say that the combination of features is not limited by the described forms, particularly the form (e.g. numbering) of the example(s), embodiment(s), or dependency of the claim(s). Moreover, this also applies to the phrase “in one embodiment”, “according to an embodiment” and the like, which are merely a stylistic form of wording and are not to be construed as limiting the following features to a separate embodiment to all other instances of the same or similar wording. This is to say, a reference to ‘an’, ‘one’ or ‘some’ embodiment(s) may be a reference to any one or more, and/or all embodiments, or combination(s) thereof, disclosed. Also, similarly, the reference to “the” embodiment may not be limited to the immediately preceding embodiment.

As used herein, any machine executable instructions, or compute readable media, may carry out a disclosed method, and may therefore be used synonymously with the term method, or each other.

The foregoing description of one or more implementations provides illustration and description but is not intended to be exhaustive or to limit the scope of the invention to the precise form disclosed. Modifications and variations are possible in light of the above teachings or may be acquired from practice of various implementations of the present disclosure.

1. A container designed for insertion in and use with a preparation machine for preparing a beverage and/or foodstuff or a precursor thereof from a precursor material stored in the container by introducing liquid in the container and passing liquid through the precursor material, the container including:
a container body comprising a bottom end and an open end, the container body forming a storage portion for containing the precursor material;
a closing member to close the storage portion at the open end of the container body; and
an annular flange-like rim at least partially made of cellulose pulp-based material, extending outwardly from the container body and connecting the storage portion and the closing member, the rim having at least a flat segment and comprising an annular force ring designed for being engaged by an enclosing member of the preparation machine,
wherein the annular force ring is made of cellulose pulp-based material and is of essentially S-shaped when seen in transversal cross-section, comprising at least:
a first portion linked to the flat segment of the rim, and forming with said flat segment an angle comprised between 2° and 85°; and
a second portion extending from the first portion on the side opposite the flat segment of the rim, said second portion comprising at least a flat and/or curved extension.

2. The container of claim 1, wherein the annular force ring comprises a third portion extending between the flat segment of the flange-like rim and the first portion of the force ring, said third portion forming a member for centering the container when the container is positioned in the preparation machine.

3. The container of claim 1, the first, second and third portions of the annular force ring are sections of the flange-like rim.

4. The container of claim 1, wherein the density of the cellulose pulp-based material of the flange-like rim, including the annular force ring, is between 200 and 500 gsm.

5. The container of claim 1, wherein the outer diameter (OD) of the container is between 50 and 70 mm.

6. The container of claim 1, wherein the flange-like rim, including the force ring, has a thickness of between 150 and 600 microns.

7. The container of claim 1, wherein the first and second portions of the force ring extend in a direction opposite the container body and beyond a plan (P) containing the flat segment of the flange-like rim, by an upward distance of extension (ha) from said plan (P).

8. The container of claim 7, wherein the distance of extension (ha) lies between 0.5 and 2 mm.

9. The container of claim 2, wherein the third portion of the force ring extends in the direction of the container body below the plan (P) containing the flat segment of the flange-like rim, by a downward distance of extension (hb) from said plan (P).

10. The container of claim 9, wherein the downward distance of extension (hb) below the plan (P) is shorter than the up-ward distance of extension (ha) above the plan (P).

11. The container of claim 1, wherein the flange-like rim, including the force ring, extends to a width of between 2 and 5 mm.

12. The container of claim 1, wherein the flange-like rim comprises a code zone.

13. The container of claim 11, wherein the code zone is located on the flat segment of the flange-like rim.

14. A set of different containers for preparing in a preparation machine a beverage and/or foodstuff or a precursor thereof from a precursor material, the container system comprising a set of different containers designed for insertion in and use with a preparation machine for preparing a beverage and/or foodstuff or a precursor thereof from a precursor material stored in the container by introducing liquid in the container and passing liquid through the precursor material, the container including:
a container body comprising a bottom end and an open end, the container body forming a storage portion for containing the precursor material;
a closing member to close the storage portion at the open end of the container body; and
an annular flange-like rim at least partially made of cellulose pulp-based material, extending outwardly from the container body and connecting the storage portion and the closing member, the rim having at least a flat segment and comprising an annular force ring designed for being engaged by an enclosing member of the preparation machine,
wherein the annular force ring is made of cellulose pulp-based material and is of essentially S-shaped when seen in transversal cross-section, comprising at least:
a first portion linked to the flat segment of the rim, and forming with said flat segment an angle comprised between 2° and 85°; and
a second portion extending from the first portion on the side opposite the flat segment of the rim, said second portion comprising at least a flat and/or curved extension,
wherein the containers comprise a container body having a total depth (Da, Db), which differs for at least two containers of the set.

15. The set of different containers according to claim 14,
wherein the containers further comprise an annular force ring extending in a direction opposite the container body and beyond a plan (P) containing the flat segment of the rim, by a distance of extension (ha1, ha2, ha3) from said plan (P), which distance of extension differs for at least two containers of the set, preferably at least three containers of the set.

16. (canceled)

17. A system comprising a container designed for insertion in and use with a preparation machine for preparing a beverage and/or foodstuff or a precursor thereof from a precursor material stored in the container by introducing liquid in the container and passing liquid through the precursor material, the container including:
a container body comprising a bottom end and an open end, the container body forming a storage portion for containing the precursor material;
a closing member to close the storage portion at the open end of the container body; and
an annular flange-like rim at least partially made of cellulose pulp-based material, extending outwardly from the container body and connecting the storage portion and the closing member, the rim having at least a flat segment and comprising an annular force ring designed for being engaged by an enclosing member of the preparation machine,
wherein the annular force ring is made of cellulose pulp-based material and is of essentially S-shaped when seen in transversal cross-section, comprising at least:
a first portion linked to the flat segment of the rim, and forming with said flat segment an angle comprised between 2° and 85°; and
a second portion extending from the first portion on the side opposite the flat segment of the rim, said second portion comprising at least a flat and/or curved extension and a machine for preparing a beverage and/or foodstuff or a precursor thereof, the machine including:
a container holder for holding the capsule at least at the flange-like rim;
a liquid injection means for feeding liquid in the container;
a spring-biasing valve member for engaging the force ring of the container when the capsule is inserted in the machine;
a processing unit for processing the precursor material of the container, the processing unit comprising the penetrator, and;
an electrical circuitry to control the processing unit.

18. (canceled)
